(19) United States
(12) Patent Application Publication
(10) Pub. No.: US 2014/0132000 A1
(43) Pub. Date: May 15, 2014

(54) TUBULAR ELEMENTS COUPLING

(71) Applicants: Ra'anan Ben-Horin, D.N. Jordan Valley (IL); Avi Levi, Kahal (IL); Alexey Slavinsky, Kfar Hittim (IL); Boaz Zur, DN Bikat Beit Hakerem (IL)

(72) Inventors: Ra'anan Ben-Horin, D.N. Jordan Valley (IL); Avi Levi, Kahal (IL); Alexey Slavinsky, Kfar Hittim (IL); Boaz Zur, DN Bikat Beit Hakerem (IL)

(73) Assignee: AMIAD WATER SYSTEMS LTD., D.N. Upper Galil 1 (IL)

(21) Appl. No.: 14/125,476

(22) PCT Filed: Jun. 13, 2012
(86) PCT No.: PCT/IL2012/050204

§ 371 Date: Dec. 11, 2013

Related U.S. Application Data
(60) Provisional application No. 61/497,138, filed on Jun. 15, 2011.

(51) Int. Cl. F16L 21/06; F16L 21/02; F16J 15/10

(52) U.S. Cl. CPC F16L 21/06; F16J 15/10; F16L 21/02
USPC 285/373; 285/420; 277/607

(57) ABSTRACT

Provided is a coupler including two or more shell segments, each pivotally coupled at a pivot end to a rigid link, and being securable to one another at a locking end thereof by a locking mechanism, each shell segment is configured with a complimentary tubular element seat and at least a pair of substantially parallel radial tubular element engagement formations, and an annular gasket seat, where the two or more shell segments are pivotable between a closed position in which they complete a substantially closed shape, and an open position where at least one of the two or more shell segments is pivotally displaced with respect to the link and apart from one another.

### FIELD OF DISCLOSED SUBJECT MATTER

The presently disclosed subject matter relates to couplings configured for coupling adjoining ends of two tubular elements. In particular the disclosed subject matter provides a coupling configured for coupling two tubular elements extending substantially coaxially in an end-to-end relation.

### BACKGROUND OF DISCLOSED SUBJECT MATTER

Coextensive coupling of two tubular elements to one another, at a sealingly tight fashion is widely exercised in a variety of fields and numerous solutions have been proposed for obtaining such couplings.

Amongst the requirements of coextensive tubular coupling are readiness of the coupler and the speed at which the tubular elements can be coupled, space required at the coupling vicinity, i.e. the ability to mount the coupler also at a tight space, strength of coupling, i.e. its capability to retain loads and forces and prevent detachment of the tubular elements, sealing quality, the need for special tools, etc.

### SUMMARY OF DISCLOSED SUBJECT MATTER

The presently disclosed subject matter provides a coupler and coupling system for coupling two tubular elements extending coaxially in an end-to-end relation, where each tubular element is configured at or adjacent a respective end thereof with a flanged or grooved end.

The term tubular element as used hereinafter in the specification and claims denotes any tubular element either an extension of a device (e.g. filter, valve, etc.) or an independent pipe section, having any size, cross-section and shape, and made of any suitable material. Accordingly, the tubular elements can have a circular cross-section or other polygonal shapes, and further, said two tubular elements can be similar in size and shape or have different parameters, e.g. have differing diameters or different cross-section.

A coupler according to first example of the present disclosed subject matter comprises two or more shell segments each pivotally coupled at a pivot end to a rigid link, and being securable to one another at a locking end thereof by a locking mechanism, each shell segment is configured with a complimentary tubular element seat and at least a pair of substantially parallel radial tubular element engagement formations, and an annular gasket seat.

This arrangement provides that the two or more shell segments are pivotable between a closed position in which they complete a closed shape, and an open position wherein at least one of the two or more shell segments is pivotally displaced with respect to the link and apart from one another.

A radial tubular element engagement formation is referred to as a radially inwardly extending rib (at times referred to as a ‘key’) configured for arresting engagement with a corresponding annular grove of a respective tubular element end, or as a radially outwardly extending groove configured for arresting engagement with a corresponding annular rib (at times referred to as a ‘flange’) of a respective tubular element end.

It is appreciated that a coupler according to the disclosed subject matter can comprise a set of axially extending radial tubular element engagement formations, consisting of one or a combination of radially inwardly extending ribs and radially outwardly extending grooves, or radially outwardly extending ribs and radially inwardly extending grooves.

Where a set of axially extending radial tubular element engagement formations is provided, it is appreciated that said formations can extend at substantially equal radii or be stepped (i.e. said formations having an increasing radii in the case of radially inwardly extending ribs, and having a decreasing radii in the case of radially outwardly extending grooves, when measured form a respective end of the tubular element).

The link is secured to each of the two or more shell segments by one or more hinge ears extending from the pivot end of the two or more shell segments.

The locking mechanism, according to one particular example is a toggle mechanism comprising a locking link pivotally articulated at one end thereof to the locking end of a first shell segment and at an opposite end pivotally coupled with a toggle handle configured with a locking end for engaging with a locking shoulder configured at the locking end of a second two or more shell segment.

According to another aspect of the disclosed subject matter there is provided a coupling system comprising two or more shell segments each configured with a complimentary tubular element seat and at least a pair of substantially parallel radial tubular element engagement formations, and an annular gasket seat, and being securable to one another by a locking mechanism comprising a bolt guide received within respective ends of a first shell segment and a bolt fastener received within respective ends of a second shell segment.

According to a particular example, at least one of a pair of a respective bolt guide and bolt fastener is a floating member.

The term ‘floating’, at times referred to as ‘self aligning’, indicates that the respective element has at least one degree of freedom with respect to the respective shell segment, so as to facilitate easy insertion and coupling of a bolt extending through the bolt guide with the bolt fastener (e.g. a nut), thereby overcoming miss alignment of the mechanical components which may reside owing to low tolerances which may be accumulative, and/or poor positioning.

A floating bolt guide or bolt fastener can have rotational freedom about an axis extending parallel to a longitudinal axis of the coupler, i.e. corresponding with a longitudinal axis of the tubular elements to be coupled thereby.

According to one particular example floating of the bolt guide and bolt fastener is obtained by a cylindrical receptacle formed in the respective shell segment, extending substantially parallel to a longitudinal axis of the tubular element seat, and a cylindrical body rotationally received within said cylindrical receptacle, with an axis of the bolt guide and bolt fastener extending perpendicular to a roll axis of said cylindrical body.

According to one particular example the bolt guide and bolt fastener are unitary and interchangeable.

According to another particular example rotation of the cylindrical body within the cylindrical receptacle is restricted such that an axis of the bolt guide and the bolt fastener become readily coaxial (axially aligned) upon insertion of a bolt there through.

According to another aspect of the disclosed subject matter there is disclosed a method for coupling two tubular elements extending coaxially in an end-to-end relation, the method comprising the following steps:
a. placing a first tubular element within the tubular element seat of a first shell segment and positioning it such that it is axially arrested by a radial tubular element engagement formation;
b. placing a second tubular element within the tubular element seat of said shell segment and positioning it at an end-to-end position with the first tubular element, such that it is axially arrested by a radial tubular element engagement formation;
c. closing the two or more shell segments ;
d. locking the coupler at the closed position by a locking mechanism thereof.

According to a particular method a sealing gasket is fitted over adjoining ends of the tubular elements, such that the sealing gasket is placed within an annular gasket seat extending in the complimenting shells segments.

Any one or more of the following features, qualities and designs may be applied, independently or jointly, and applied respectively to any one or more of the aspects of the presently disclosed subject matter:
The two or more shell segments can be discrete (i.e. non identical) or non- discrete (i.e. identical and interchangeable);
The locking mechanism can be a toggle clamp or other locking mechanism, such as screw couplings and the like;
The annular gasket seat is configured for accommodating a hydraulic sealing gasket for imparting the coupler sealing coupling between the two tubular elements. Where the sealing gasket is omitted coupling can be obtained though without sealing;
The coupler offers rigid coupling, though according to particular examples one or both of the tubular elements is rotatable about its longitudinal axis;
The coupler offers compensation of axial tolerance between the tubular elements, however preventing axial displacement of the tubular elements once the coupler is at the closed position. However, according to a particular example some degree of freedom may reside, i.e. have some rotational and/or axial freedom with respect to the coupler;
The coupler offers compensation of radial tolerances between the tubular elements;
The two or more shell segments are configured such that at their closed position they substantially complete a closed circular path, or any other closed shape;
Substantially all components of the coupler are made of plastic material;
The annular gasket seat is a groove disposed symmetrically within the half- hells;
Pivotal couplings of the two or more shell segments with the rigid link, the locking link and between the locking link and the toggle handle can be facilitated through pivot pins inserted through respective pivot bores, or by pivot pins integral with the rigid link and the locking link pivotally engageable through pivot recesses configured at the respective pivot end of the shell segments and at the toggle handle;
The rigid link and the locking link can be configured of a single solid element or two or more parallely disposed links;
At the closed position of the coupling a surface at the respective ends of the shell segments abut one another. According to another example, the respective ends of the shell segments have only partial contact with one another, and according to yet an example a gap may extend therebetween
One of the tubular elements can be replaced by an end plate thus serving as a closure cap (end piece) sealing an end of a tubular element; said end plate configured for seating within with the tubular element seat and arresting by the radial tubular element engagement formations;
The coupler can be configured for sealingly coupling a flow control member (e.g. faucet, valve, meter, branching tubular element, etc.) interposed coaxially between two neighboring tubular elements;
A flow control member is considered any flow-related element disposed between two neighboring tubular elements, either with or without an extension extending through the coupler (e.g. faucet, valve, meter, branching tubular element, etc.);
Coupling between the flow control member and the tubular elements can be facilitated through an axial displacement ring configured for mounting over to the tubular element and axially engaging therewith, and having an external tapering surface configured for bearing within the coupler and against a corresponding tapering wall thereof, whereby applying bracing force (i.e. tightening the two or more shell segments) over the coupler elements entails resultant axial forces resulting in displacing the displacement ring and the articulated tubular element towards the flow control member;
Axial engagement between the displacement ring and the tubular element is facilitated through a radial grove configured at one of the outside surface of the tubular element and an inside surface of the displacement ring, and a radial locking projection extending from the other of the outside surface of the tubular element and an inside surface of the displacement ring; said locking projection configured for projection into said radial grove such axial forces applied to the displacement ring are transferred to the tubular element;
The displacement ring can be configured as a unitary ring elastically expendable owing to a slit, whereby the displacement ring is a so-called ‘spring ring’ configured snapping engagement of the radial locking projection with the radial grove, or vise-versa, depending on the case as disclosed above. Alternatively the displacement ring can be configured as a segmented ring composed of two or more radial segments, substantially completing a closed ring shape.
A sealing ring is disposed intermediate the flow control member and the tubular element. The sealing ring can be a hydraulic-type sealing ring or a compression (non-hydraulic) sealing ring, e.g. o-ring;
Sealing between the flow control member and a respective tubular elements is facilitated by a hydraulic seal disposed between a side wall of the flow control member and the axial displacing ring;
Sealing between the flow control member and the respective tubular elements is facilitated by one or more compression rings, disposed in an annular groove configured at the side wall of the flow control member to and/or at an end face of the tubular element.
When mounted, the respective end of the tubular element and the end of the displacement ring substantially co-extend, though an axial gap may reside, however to a limited extent, in order not to effect sealing of the coupling.

According to yet another aspect of the present disclosed subject matter there is provided a hydraulic sealing gasket made of a resilient material and having a base portion and at least one gasket leg terminating at a sealing lip, wherein radially extending support ribs are provided between an inside surface of the gasket leg and an inside surface of the base portion.

According to a particular configuration the a sealing gasket has a C-like cross- section configured with a base portion and two oppositely extending gasket legs each terminating at a sealing lip, wherein radially extending support ribs are provided between an inside surface of the gasket legs and an inside surface of the base portion.
Any one or more of the following features, qualities and designs may be applied, independently or jointly, and applied respectively to any one or more of the aspects of the presently disclosed subject matter:
The sealing gasket is symmetric and wherein said gasket legs are identical;
Said base portion is substantially flat;
The support ribs extend either or both from the inside surface of the base portion towards the inside surface of the gasket legs and from the inside surface of the gasket legs towards the inside surface of the base portion;
A gap residing between an end of the support ribs and the respective inside surface of the base portion or the inside surface of the gasket legs. Where support ribs extend from both the inside surface of the base portion and the inside surface of the gasket legs, they face one another with an interstice kept between the facing support ribs;
The support ribs can extend integrally between the respective inside surface of the base portion and the inside surface of the gasket legs;
The sealing gasket is configured for use in conjunction with a coupler for coupling two tubular elements extending coaxially in an end-to-end relation, where each tubular element is configured at or adjacent a respective end thereof with a flanged or grooved end;
The gasket legs can extend at different coaxial planes;
The base portion is stepped and is configured for sealing engagement two tubular elements of different external size (e.g. different external diameter in case of cylindrical tubular elements);
The support ribs are provided to prevent inwards collapse of the gasket legs;
The sealing gasket is made of a resilient material such as rubber, silicon rubber and the like.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is a top perspective view of a coupler according to one example of the present disclosed subject matter, assembled and coupling two tubular elements;

FIG. 1B is an exploded view of FIG. 1A;

FIG. 1C is a partially sectioned, front planner view of FIG. 1A;

FIG. 1D is a longitudinal section along line I-I in FIG. 1A;

FIG. 1E is an isometric view illustrating an assembly step of the coupler system of FIG. 1A;

FIG. 1F is a consecutive assembly step of the coupler system of FIG. 1E;

FIG. 1G is a modification of the example of FIG. 1A wherein the bolt guide and bolt fastener are floating members with restricted rotation

FIG. 2A is a perspective view of a coupler according to another example of the present disclosed subject matter, assembled and coupling two tubular elements;

FIG. 2B is an exploded view of FIG. 2A;

FIG. 2C is a section taken along line II-II in FIG. 2A;

FIG. 2D is a section taken along line III-III in FIG. 2A;

FIG. 2E is an isometric view illustrating an assembly step of the coupler system of FIG. 2A;

FIG. 2F consecutive assembly step of the coupler system of FIG. 2E;

FIG. 3 a perspective exploded view of a coupler according to a modification of to the example of FIG. 2;

FIG. 4A is an isometric view of a sealing gasket according to the present disclosed subject matter;

FIG. 4B is a planer section of taken along line IV-IV in FIG. 4A;

FIG. 4C is a planer section of taken along line V-V in FIG. 4B;

FIGS. 4D to 4F are enlargements of modifications of the portion marked E in FIG. 4C;

FIGS. 5A to 5D are schematic representations of a section through a coupling system according to further examples of the disclosed subject matter;

FIGS. 6A to 6H illustrate a multi-shell coupler according to a modification of the example of FIG. 1, describing consecutive steps in mounting and coupling the coupler over tubular elements;

FIGS. 7A to 7F illustrate a multi-shell coupler according to a modification of the example of FIG. 2, describing consecutive steps in mounting and coupling the coupler over tubular elements;

FIG. 8A is a longitudinal (front) view of a coupler system according to yet an example of the disclosed subject matter, configured for supporting a flow control member between two coupled pipe segments;

FIG. 8B is a side view of FIG. 8A;

FIG. 8C is a top view of FIG. 8A;

FIG. 8D is an enlargement of the portion marked B in FIG. 8C;

FIG. 9A is a particular example of a coupler configuration useful in a system of the type disclosed in FIG. 8; and

FIG. 9B is yet another particular example of a coupler configuration useful in a system of the type disclosed in FIG. 8.

### DETAILED DESCRIPTION OF EMBODIMENTS

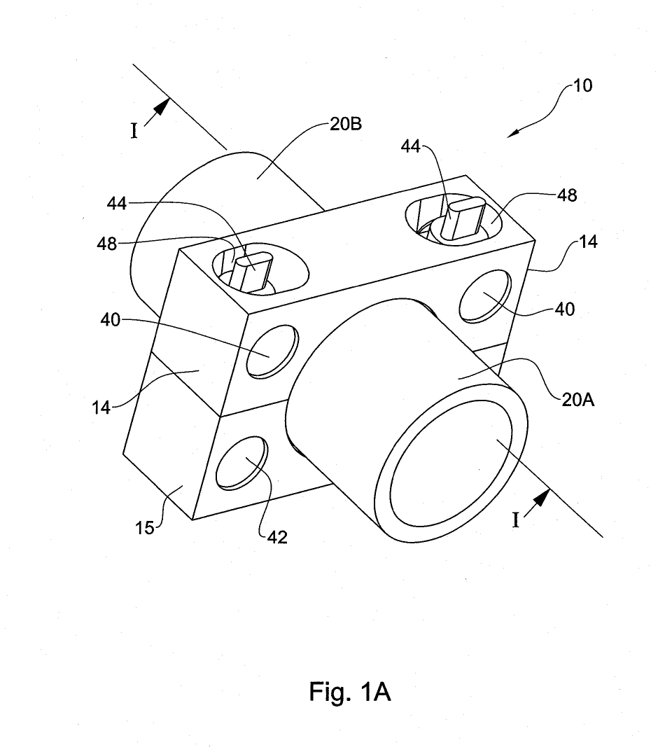

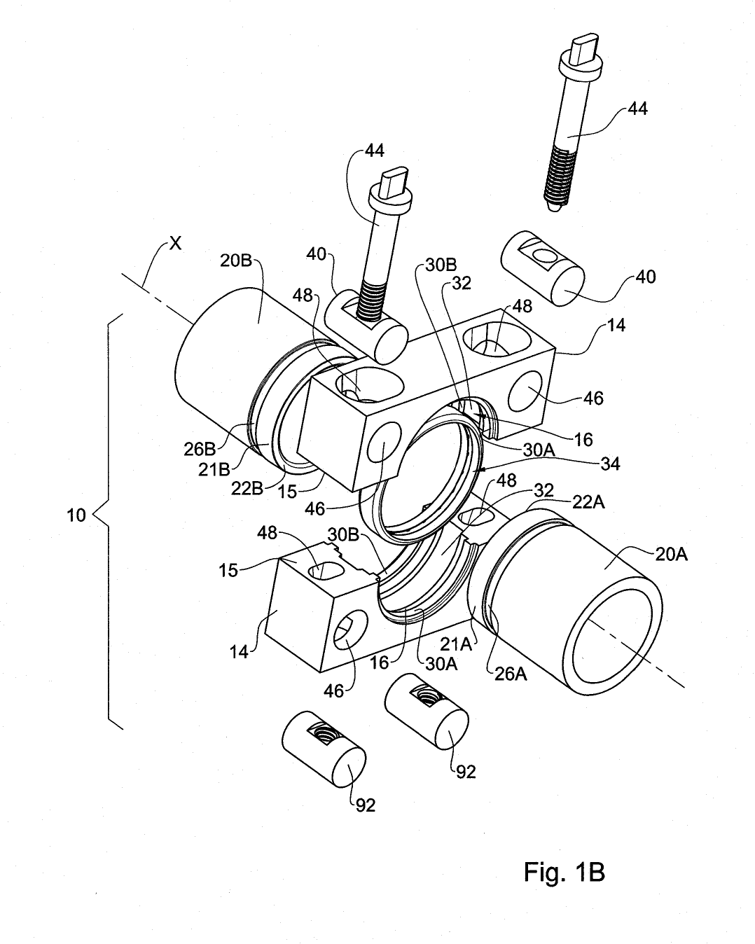

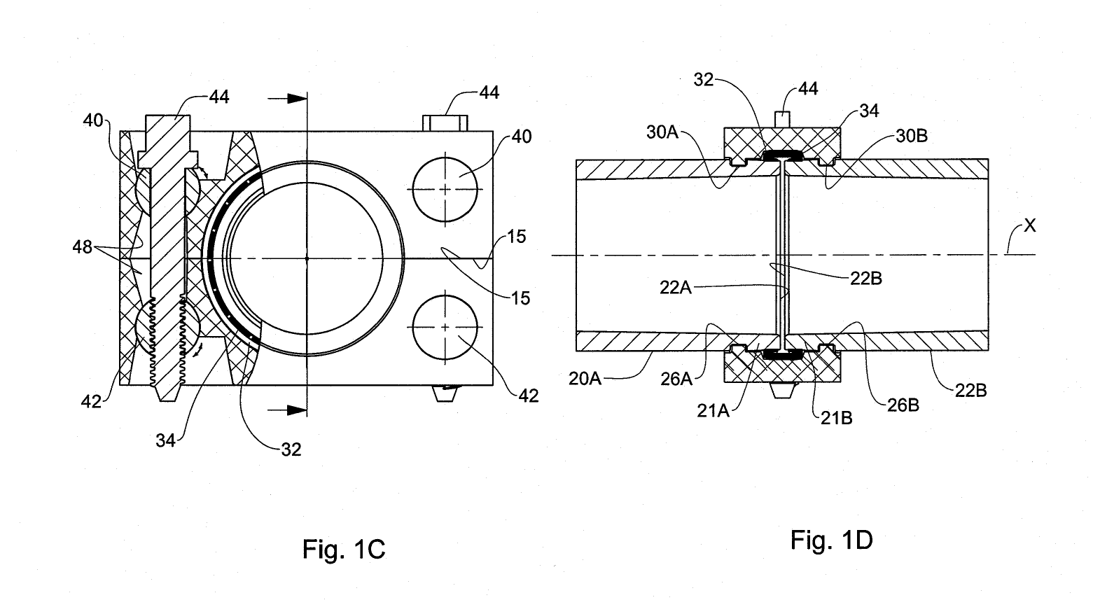

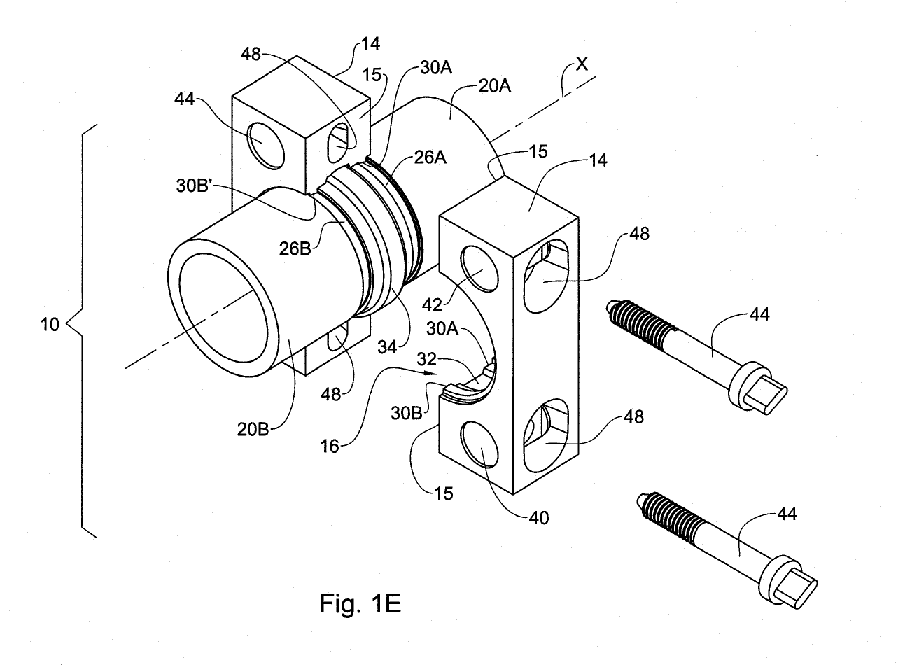

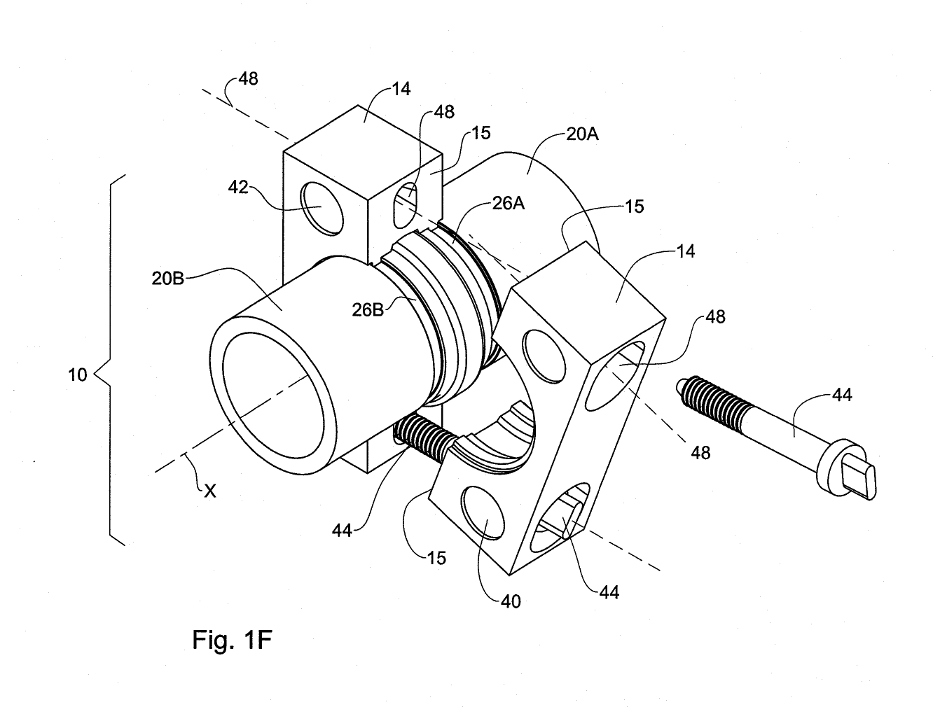

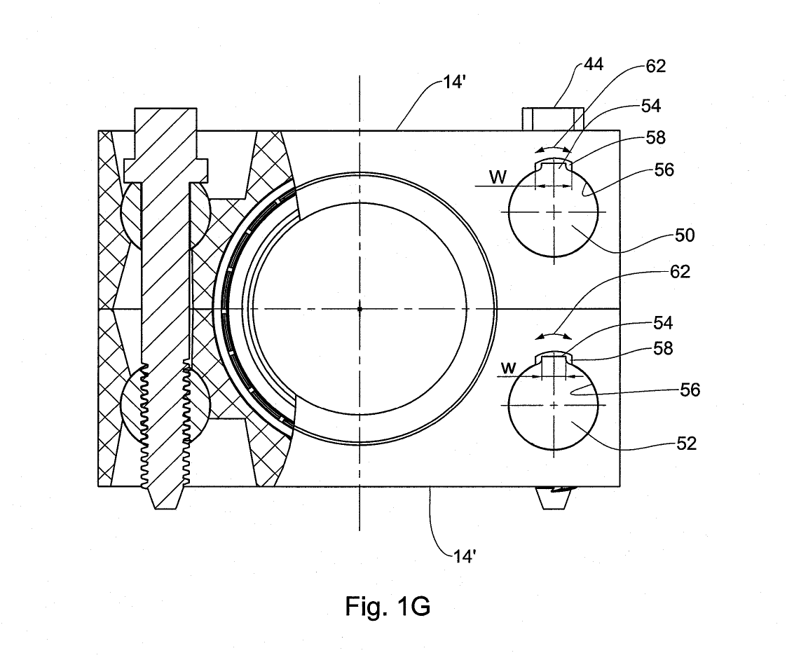

Attention is first directed to FIGS. 1A-1F of the drawings directed to a tubular element coupler system in accordance with the first example of the present disclosed subject matter generally designated 10.

As can best be seen in FIG. 1B of the drawings the coupler comprises a pair of shell elements 14 made of rigid material e.g. metal, durable/reinforced plastic material, to etc., each configured with a tubular element seat portion 16 which together form a complementary tubular element seat configured, in the present example for seating two cylindrical segments of tubular elements designated 20A and 20B. The half shells 14 are each configured with a flat surface 15 for engagement with the mating surface of the corresponding shell, as will be discussed hereinafter.

Each of the tubular elements 20A and 20B is fitted with a substantially flat planar end 22A and 22B respectively, extending about a plane substantially normal to a longitudinal axis X extending through the tubular elements. As can further be noted, each of the tubular elements 20A and 20B is configured near its fore end 22 with an annular groove 26A and 26B, respectively.

In the particular illustrated example both tubular elements 20A and 20B are cylindrical and have substantially equal external diameter and are configured for snuggly receiving within the tubular element seat composed of the complementary portions 16 of each of the shell segments 14. It is however appreciated that one or both of the tubular elements can be loosely received and coupled by the coupler, i.e. having some rotational and/or axial freedom with respect to the coupler.

As can further be seen, each of the shell segments 14 is further configured with a pair of substantially parallely extending tubular element engagement element formations designated 30A and 30B, which in the present example are radially extending ribs (often referred to keys) configured for arresting engagement with the corresponding annular grooves 26A and 26B of the tubular elements 20A and 20B, respectively.

Disposed between the tubular element engagement formations 30A and 30B (i.e. at the seat portion 16) there is a gasket seat 32 which at the assembled, closed position of the coupler gives rise to an annular shaped gasket seat for receiving therein a hydraulic sealing gasket 34 configured for mounting over the end portions 21A and 21B of the tubular elements 20A and 20B respectively, and for receiving within the annular groove 32 and hydraulically sealing the coupling of the tubular elements, thus preventing any fluid leak therefrom, as known in the art.

The two shell segments 14 of the coupler are securable to one another into a closed, tight position wherein the complementary tubular element seats give rise to a closed circle shape. Securing at the closed state is carried out by a locking mechanism comprising a bolt guide 40 disposed in one shell segment 14 (typically the one through which a bolt is introduced) and a pair of corresponding bolt fasteners 42 disposed in the opposite shell segment 14, with a pair of bolts 44 extend through bores 48 extending through respective ends of the shells 14 and configured for extending through the bolt guides 40 and screw coupling with the respective bolt fasteners (nuts) 42. It is noted that the bolts and nuts may be introduced through either of the shells segments.

It is however noted that the bolt guides 40 and the bolt supports 42 are cylindrical elements disposed within corresponding cylindrical bores 46 giving rise to a so-called floating configuration i.e. being self-aligning such that the bolts 44 may be easily introduced through the bolt guides 40 and the bolt fasteners (nuts) 42 thus overcoming any misalignment of the above components.

It is further appreciated that in the particular illustrated example the bolt guides 40 are not threaded whilst the bolt fasteners namely bolts 42 are threaded and configured for screw coupling with the bolts 44 however, in accordance with different examples, the bolt guides may be threaded in correspondence, rendering these components to be non-discrete.

In assembly of the tubular element coupling system 10, and as can be seen with respect to FIGS. 1E and 1F and with reference to previous figures, the coupler is first opened i.e. the shell segments 14 are detached from one another by unscrewing the bolts 44 and separating the shell segments from one another.

Then, the two tubular elements 20A and 20B are brought to an end-two-end position as illustrated in the drawings and the hydraulic sealing gasket 34 is placed over the mating ends 21A and 21B of the tubular elements 20A and 20B. The assembled tubular elements, now coaxially extending, are then placed within the tubular element seat of one of the shell segments such that the sealing gasket 34 is received within the annular gasket seat 32 and the respective grooves 26 are placed over the annular ribs 16 (locks).

Then, the coupler is closed by attaching the two half-shell segments 14 giving rise to a complimentary secular shape of the tubular element seat, and securing the shell segments 14 tightly towards one another by bolts 44 until the flat surfaces 15 are flush and abut against one another in a tight and secure manner and whereby the tubular elements 20A and 20B are prevented from detaching from one another and are securely and sealingly coupled. However, it is appreciated that the respective ends of the shell segments have only partial contact with one another, and according to yet an example a gap may extend therebetween.

It is appreciated that the floating arrangement of the bolt guides 40 and of the bolt fasteners 42 enables easy mounting and securing of the bolts at the initial stage (FIG. 1F) where the shell segments 14 are not necessarily parallel to one another and the bores 48 of the two shell segments are non coaxial, whereby introducing of the bolt 44 renders self alignment of the bolt guide 40 and the bolt fastener 42 to facilitate tight and secure fastening of the assembled coupler.

Turning now to FIG. 1 G, there is illustrated a modification of the example illustrated in connection with FIGS. 1A-1F. In the example of FIG. 1G the bolt guides 50 and the bolt fasteners 52 (nuts) are configured as cylindrical elements having their longitudinal axis extending parallel to the longitudinal axis of the tubular element seat and however configured with a laterally projecting axial projection 54 and wherein the receiving bore 56 within each of the shell segments 14′ is substantially cylindrical and is configured with a longitudinal radial outwardly facing groove designated 58. The arrangement is such that the width w of the radial projection 54 is narrower than the width W of the groove 58, whereby the bolt guide 50 and the bolt fastener 52 are free to angularly displace as represented by arrowed line 62, however about a restricted angular span.

The arrangement disclosed in FIG. 1G provides a floating arrangement of the bolt guide and bolt fastener, yet within a restricted angular range, thus to avoid out-of- range displacement of the respective components (i.e. to prevent that the bolt guide and bolt fastener rotate within the respective shell to an extent that the bolt bore is not accessible for penetration by the bolt).

Unlike a toggle-like fastening mechanism, the fastening mechanism disclosed in connection with FIGS. 1A-1G may be mounted and installed also at substantially tight sites, where only little space is available for manipulating the components of the coupler.

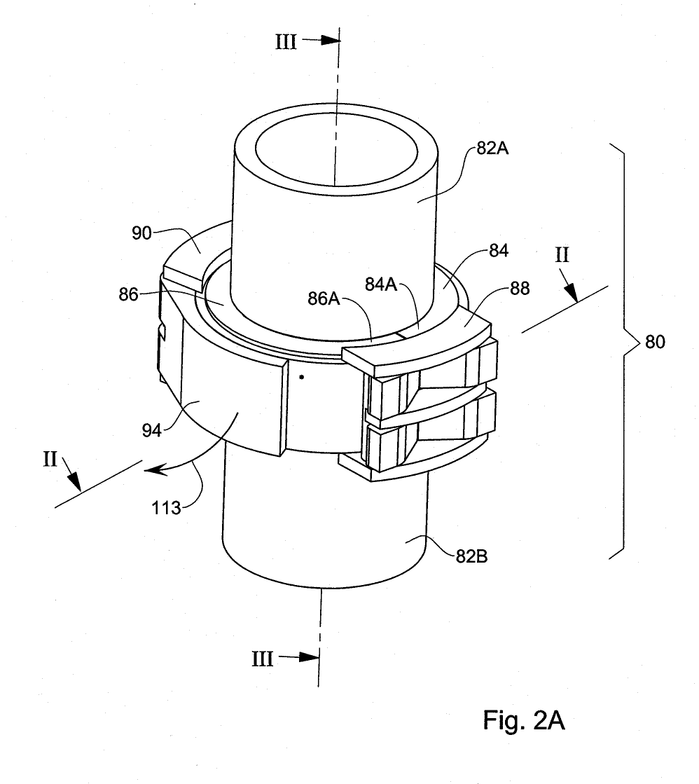

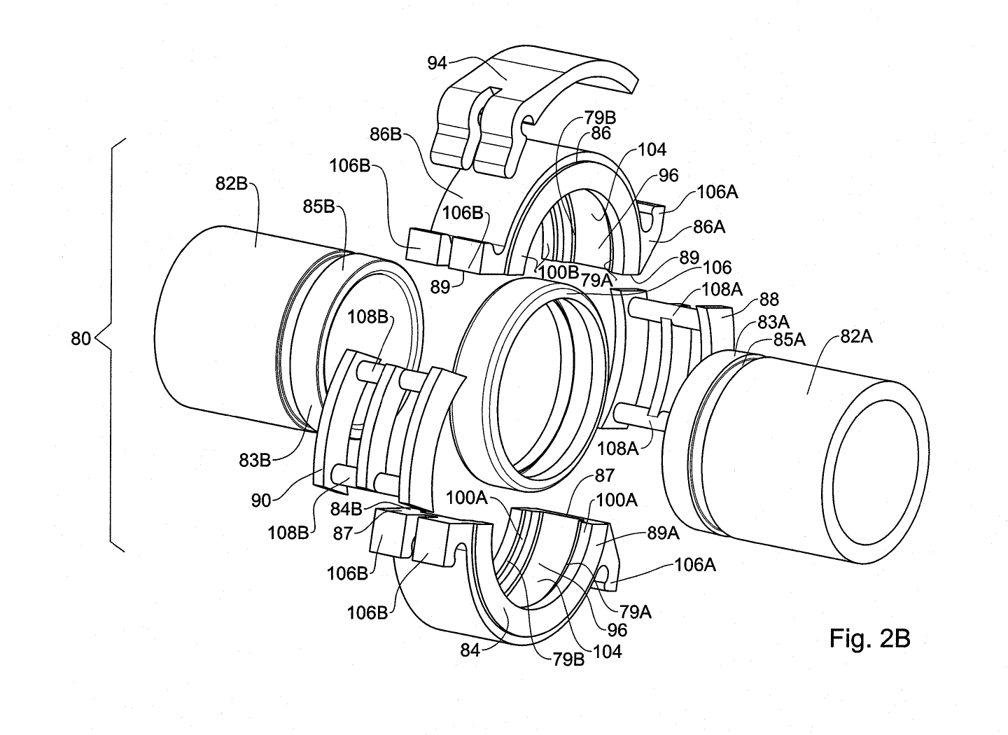

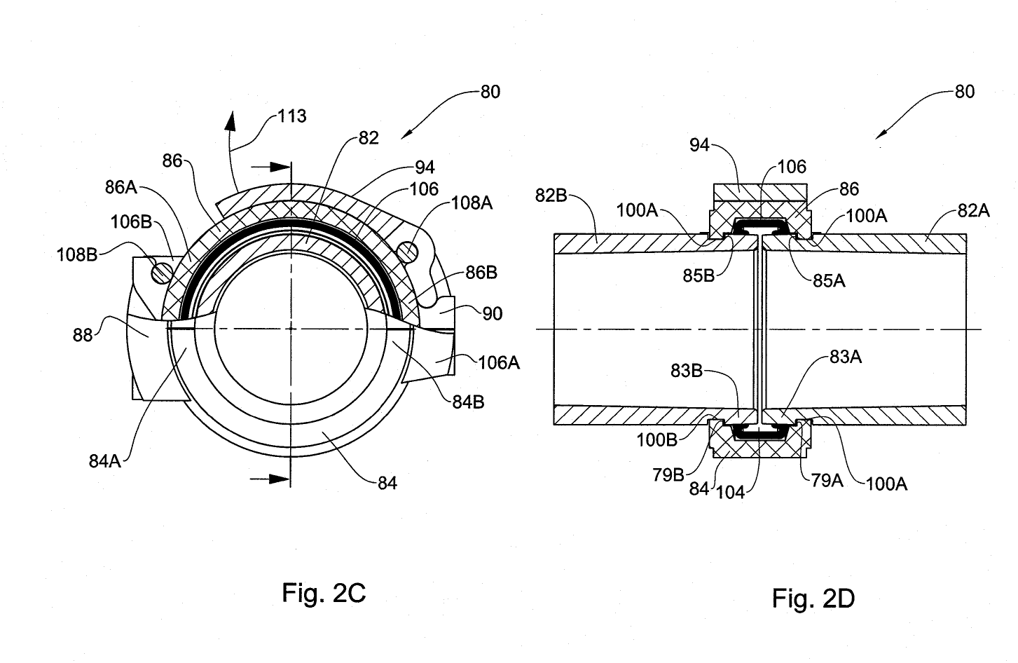

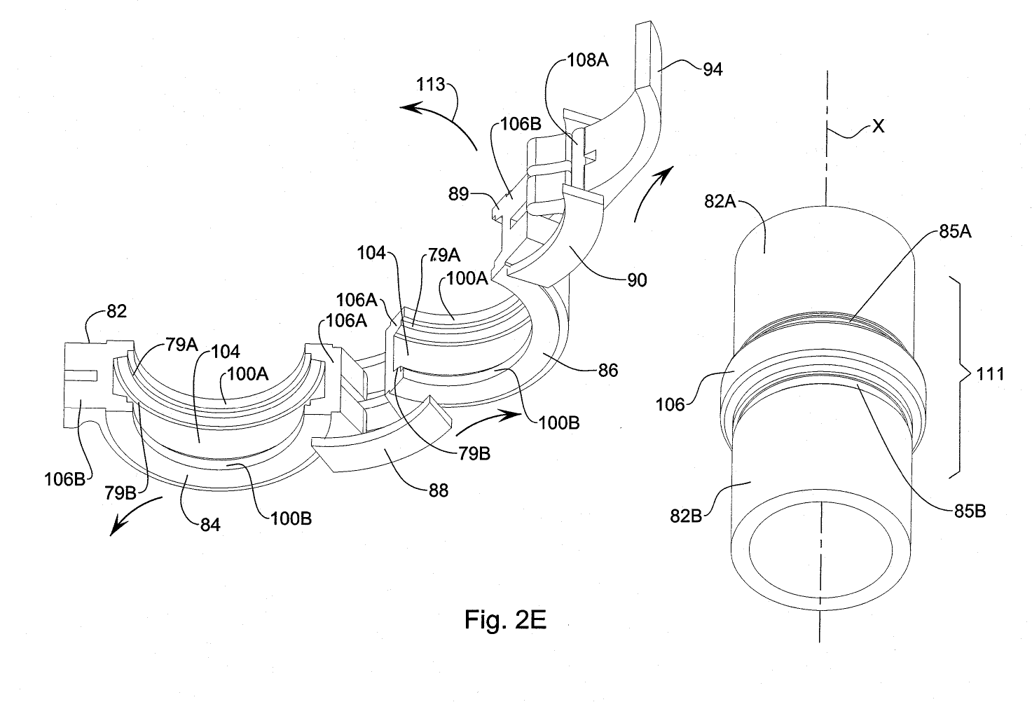

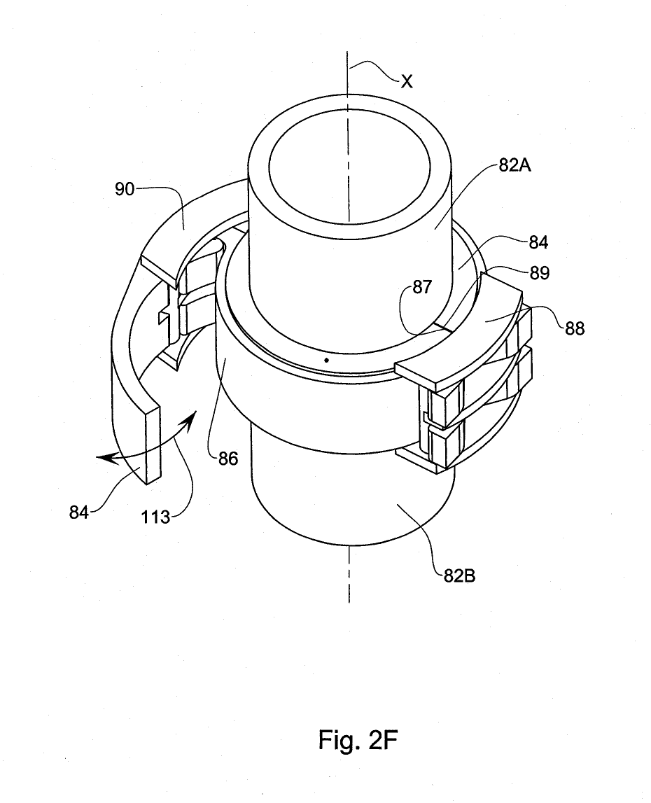

Turning now to FIGS. 2A-2F there is illustrated another tubular element coupling system generally designated 80 configured for sealingly coupling a pair of coaxially extending tubular elements designated 82A and 82B, of similar structure as discussed hereinbefore in connection with FIGS. 1A to 1F. The coupler comprises a first half shell segment 84 and a second half shell segment 86 pivotally secured at a respective pivot end 84A and 86A to a rigid link 88 and at an opposite, locking end 84B and 86B to a locking link 90 of a locking mechanism with a locking lever 94 pivotally secured to the locking link 90 and constituting together a toggle-type locking mechanism.

It is further noted that each of the half shell segments 84 and 86 is configured with a flat surface 87 and 89 respectively, at the respective ends of each shell segment, wherein at the closed position of the coupler, said surfaces are configured for flush bearing against one another. However, according to some particular examples, the mating surfaces of the half shell segments 84 and 86 are not flat but may rather assume any complimentary shape providing adequate surface contact therebetween.

Further noted, best in FIG. 2B, each of the shell segments 84 and 86 is configured with a complementary tubular element seat 96, each configured with a pair of substantially parallel radial tubular element engagement formations in the form of inward extending radial ribs (keys) designated 100A and 100B and defining between them an annular gasket seat 104 for accommodating a hydraulic gasket seal 106 as discussed hereinabove in connection with the previous example. Typically, the gasket seat is spaced from the radial ribs 100 by annular stepped shoulder 79A and 79B, whereby the gasket does not engage the inner surface of the radial ribs 100.

The arrangement of the coupler system 80 is such that the rigid link 88 together with the locking link 90 impart the two shell segments 84 and 86 additional degrees of freedom for displacement with respect to one another and with respect to the tubular elements 82A and 82B during the assembly and mounting, namely opening and closing of the coupler about the tubular elements, thus rendering it suitable for mounting also at substantially tight space and at such locations wherein access and manipulation is limited.

It is noted that each of the shell segments 84 and 86 is pivotally articulated at the respective links 88 and 90 by a pair of hinge ears 106A and 106B for pivotal arresting of a pivot pin 108A and 108B of the rigid links 88 and 90, respectively.

Each of the shell segments 84 and 86 is configured with an annular stepped shoulder 79A and 79B respectively, for supporting the annular end portions 83A and 83B of the tubular elements.

For assembling of a coupler system in accordance with the disclosed subject matter, a first stage is performed by adjoining the two tubular elements 82A and 82B into a face-to-face arrangement as illustrated in FIG. 2E, and mounting the hydraulic sealing gasket 106 over the annular end portions 83A and 83B of the tubular elements, respectively, as illustrated in the sub-assembly of the tubular element generally designated 111 (FIG. 2E), wherein the two tubular elements 82A and 82B extend coaxially along the longitudinal axis X.

Then, the coupler is opened by displacing the lever 94 into the open position, in direction of arrows 113 and wherein the two shell segments 84 and 86 are pivotally displaced into the open position as represented in FIG. 2E.

Then, the coupler is positioned over the tubular element assembly 111 such that the hydraulic sealing gasket 106 resides within the annular gasket seat 104 and wherein the radial tubular element engagement formations, namely radially inward extending ribs 100 engage with the corresponding annular grooves 85A and 85B of the tubular elements 82A and 82B, whereupon the shell segment 86 is then closed over the assembly 111, in direction of arrowed line 113 into the position of FIG. 2F, whereupon the two shell segments 84 and 86 brace the coupling zone of the tubular element 82A and 82B in a rigid and sealing fashion. Locking of the assembly is obtained by displacing the locking lever 84 of the toggle mechanism into the closed position of FIG. 2A (in closing direction of arrow 113).

The example illustrated in FIG. 3 is to a great extent similar to that disclosed in connection with FIGS. 2A-2F however wherein the rigid link now designated 130 and the locking link 140 are constructed in the form of a plate-like element configured with two pivot pins 130A and 130B, and 140A and 140B (the latter not seen) configured for arresting by corresponding pivot lugs 146A and 146B for the rigid link 130 and 148A and 148B for pivot arresting of the pins of the locking link 140.

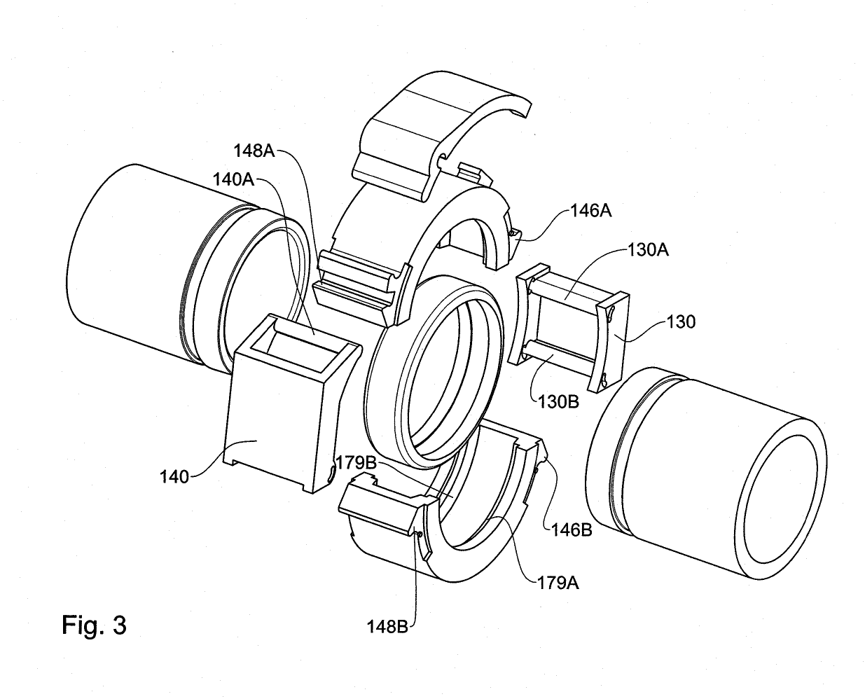

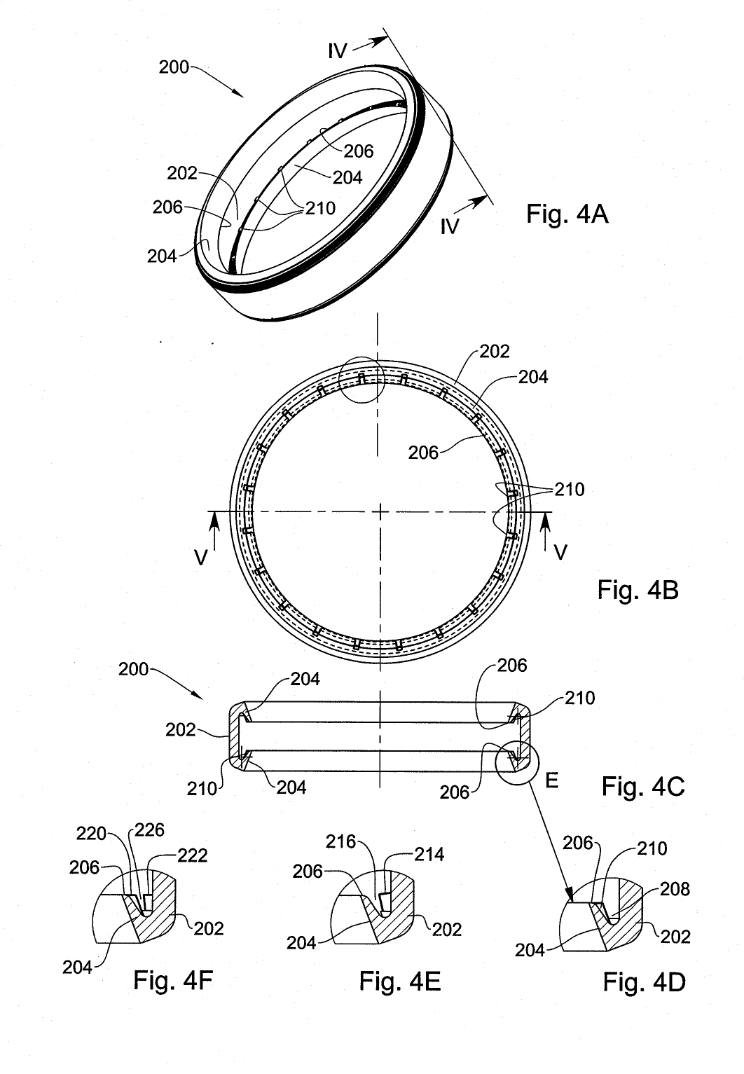

Turning now to FIGS. 4A-4F there is illustrated a hydraulic sealing gasket in accordance with another aspect of the present disclosed subject matter and generally designated 200. The sealing gasket 200 has a C-like cross section configured with a thickened base portion 202 and two oppositely extending gasket legs 204, facing axially towards one another, each terminating at a sealing lip 206. The hydraulic sealing gasket 200 is typically made of a resilient material such as rubber, silicon rubber and the like and wherein the sealing lips 206 are substantially thinner and thus more flexible than the gasket legs 204 for increased hydraulic sealing effect.

It is further noted that a plurality of support ribs 210 are provided, said support ribs configured for restricting the deformation/deflection of the sealing lips 206.

In the enlarged view of FIG. 4D, the support ribs 210 extend from the gasket leg 204 towards the base portion 202, leaving a gap 208 therebetween.

In the example of FIG. 4E, the support ribs 214 extend from the base portion 202 towards the support leg 204 leaving a gap 216 therebetween.

In the example of FIG. 4F, two support ribs are provided, namely support rib 220 extending from the gasket leg 204 towards the base portion 202 and a second coplanar support rib 222 extends from the base portion 202 towards the gasket leg 204, with a gap 226 extending therebetween.

The arrangement is such that the support ribs extend in a radial direction whereby they restrict the radial inward deformation of the gasket legs and sealing lips.

Whilst in the present example the sealing gasket 200 is illustrated as a symmetric article, it is appreciated that different modifications may reside, for example, the gasket legs can extend at different coaxial planes, i.e. extend at different radii and thus serve for sealing engagement between two tubular elements having different external diameter though extending coaxial within a coupling element.

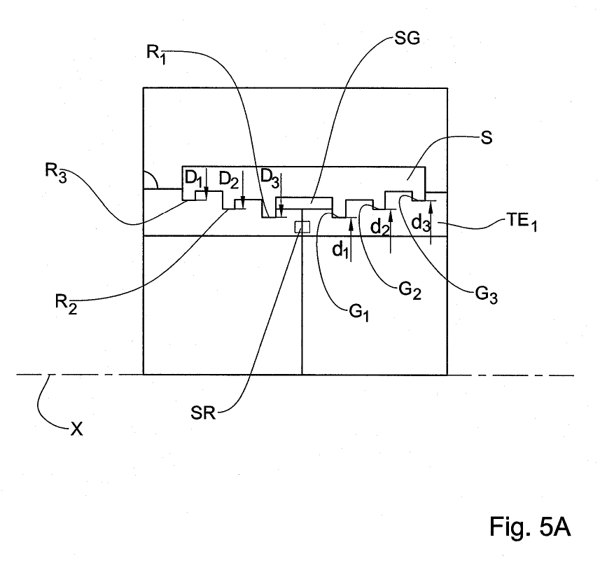

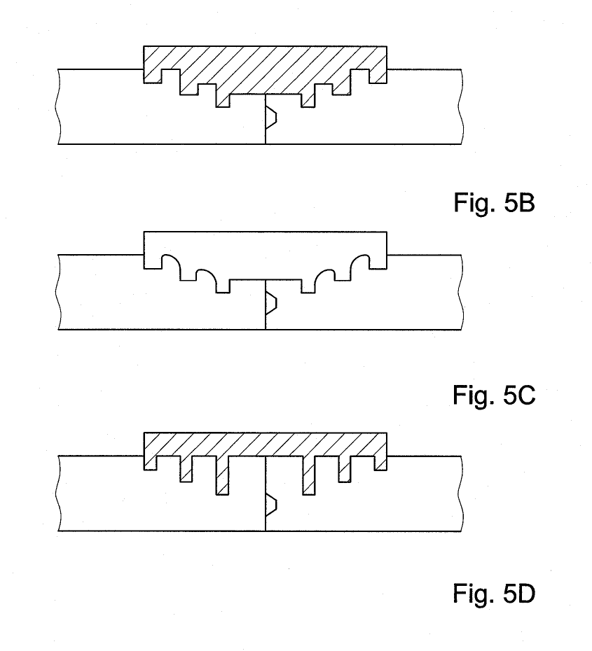

Turning now to FIG. 5 there is a schematic illustration of a coupler system in accordance with a modification of the disclosed subject matter wherein two tubular elements are provided designated TE₁ and TE₂ extending if a face-to-face configuration and being of substantially similar external diameter. In the present example each of the tubular elements is configured with three annular grooves designated G₁, G₂ and G₃ extending at corresponding increasing diameters d₁, d₂ and d₃, respectively. It is however appreciated that the number of grooves/ribs may be different (also, a different number of grooves/ribs may be provided at each end of the coupler). Furthermore, the width and depth/length of the ribs and respective grooves may change along the coupler (FIGS. 5B and 5C), and their cross-section may be other than rectangle (FIG. 5C). Such modifications can take place also within a given coupler.

Correspondingly, the shell segments of the coupler, schematically illustrated and designated S are configured with a plurality of radially inwardly extending ribs (keys) referred to as R₁, R₂ and R₃, respectively, each extending at a diameter D₁, D₂ and D₃ corresponding with the diameters of the grooves G₁, G₂ and G₃.

The annular grooves G₁, G₂ and G₃ are equally distanced from one another (though in accordance with other examples not shown, these may differ) and correspondingly the inward extending ribs R₁, R₂ and R₃ are disposed at equal distances and in correspondence with the location of the grooves, to thereby lockingly engage therewith and impart the coupler with increased locking force.

A sealing gasket SG is provided over the face-to-face coupling of the two tubular elements TE₁ and TE₂ for fluid tight coupling, as discussed hereinabove.

It is however appreciated that sealing between the tubular elements TE₁ and TE₂ may be provided by the provision of a sealing gaskets SG as illustrated in FIG. 5 or by a sealing ring SR provided between the abutting ends of the tubular elements. The sealing ring SR may be fitted at either or both the abutting ends of the tubular elements. It is further appreciated that the thickness of the grooves Gᵢ and the respective ribs Rᵢ may differ and further that the grooves Gᵢ and the respective ribs Rᵢ may assume various cross sections (i.e. as far as depth/height and shape e.g., right-angled, trapezoidal, round-ended, etc.). In addition, it is noted that the tubular elements TE₁ and TE₂ may be of equal or different diameter, as indicated herein before, and may be made of different materials.

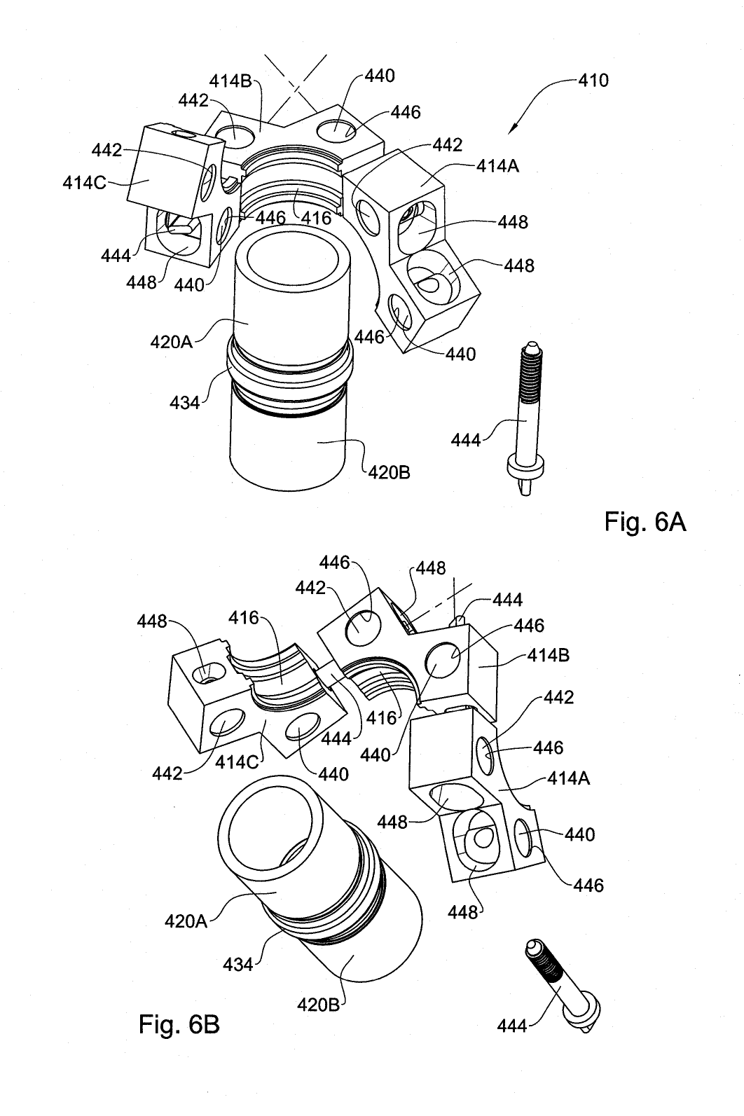

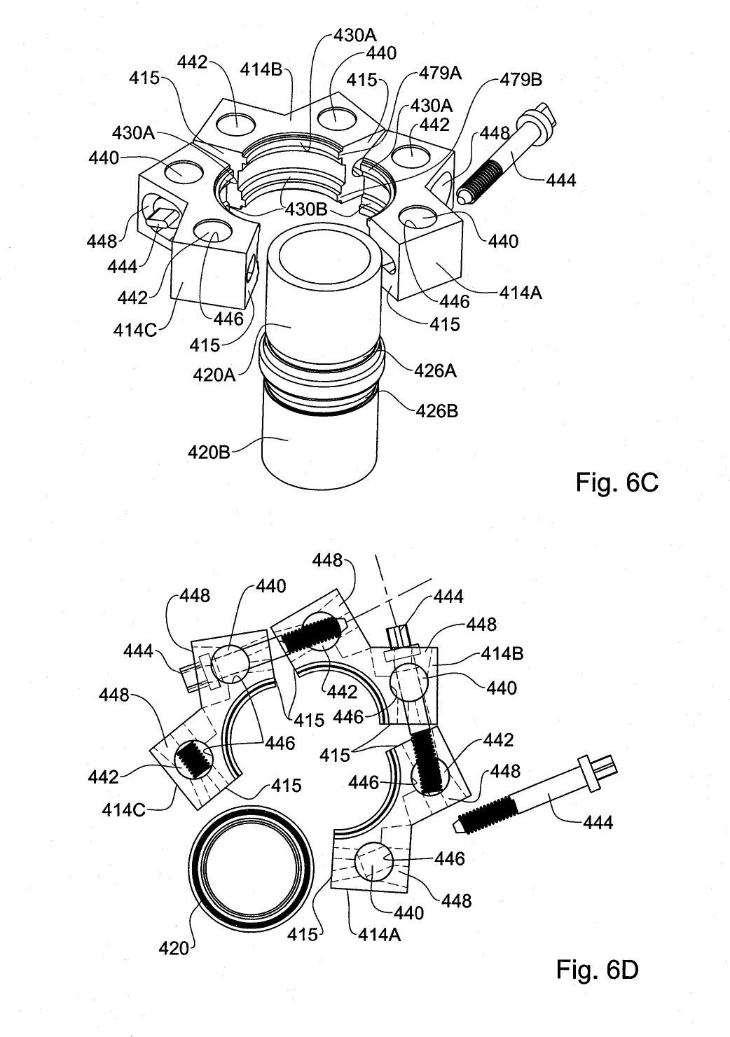

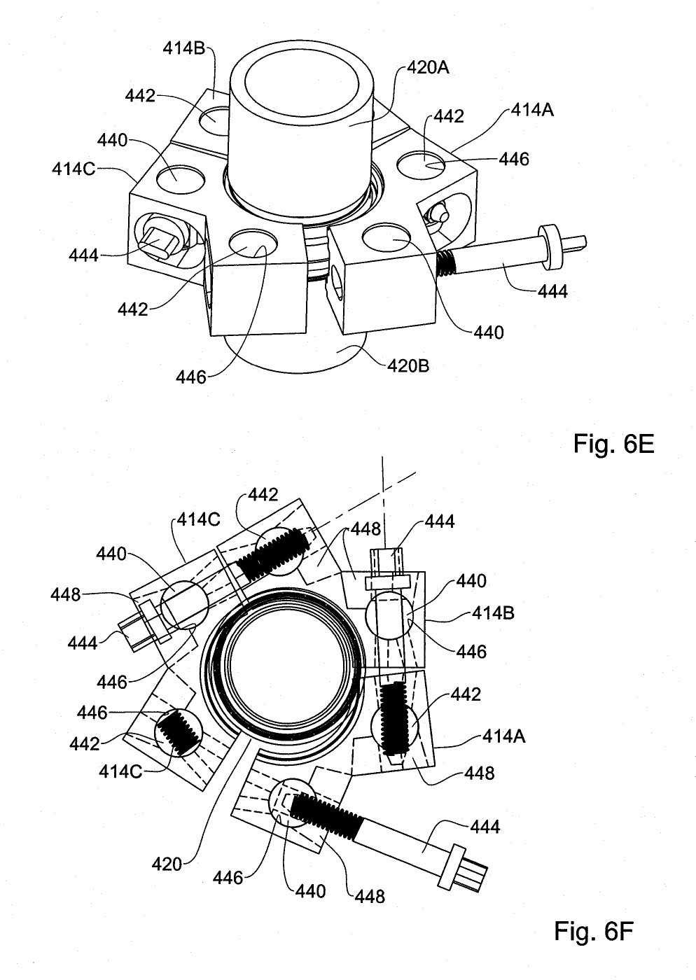

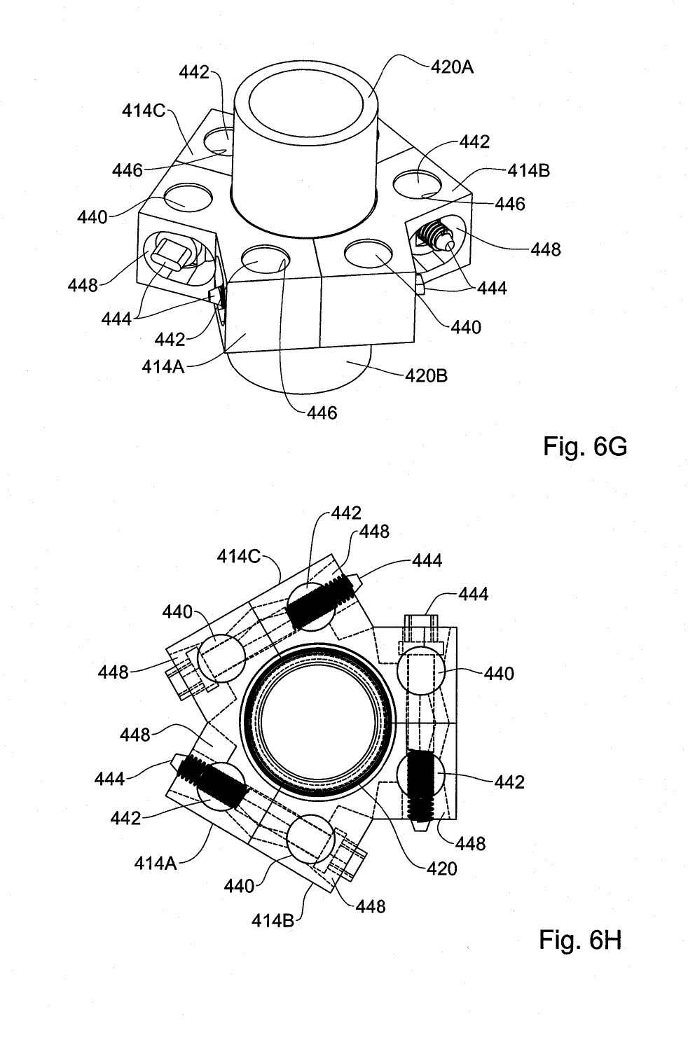

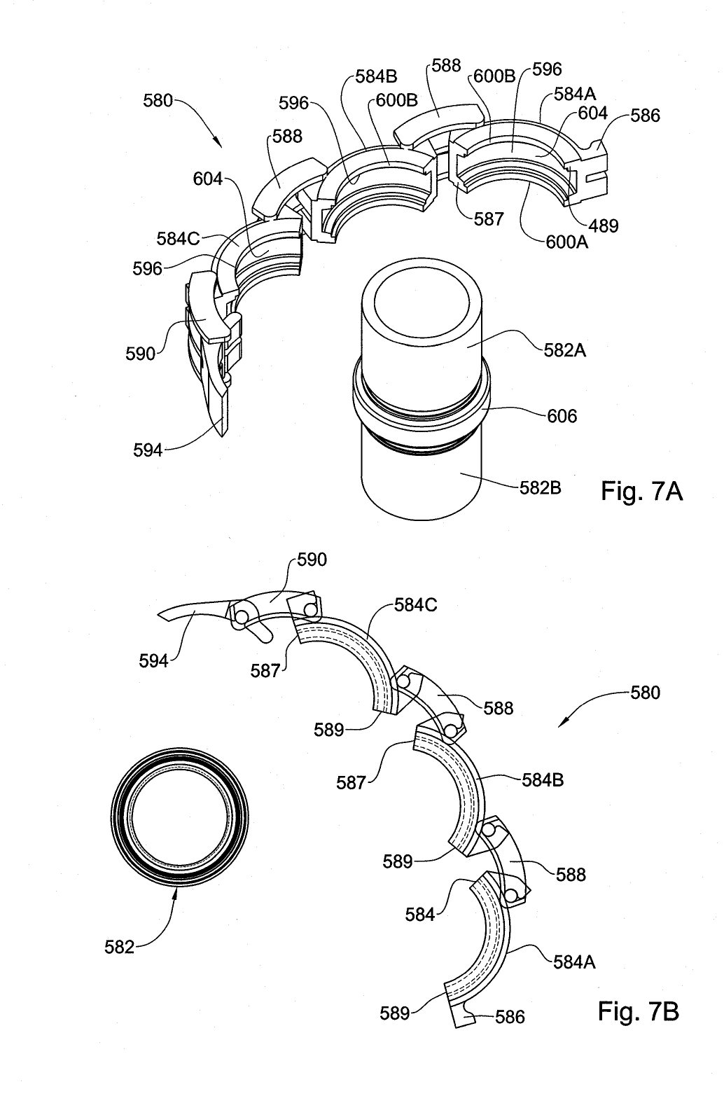

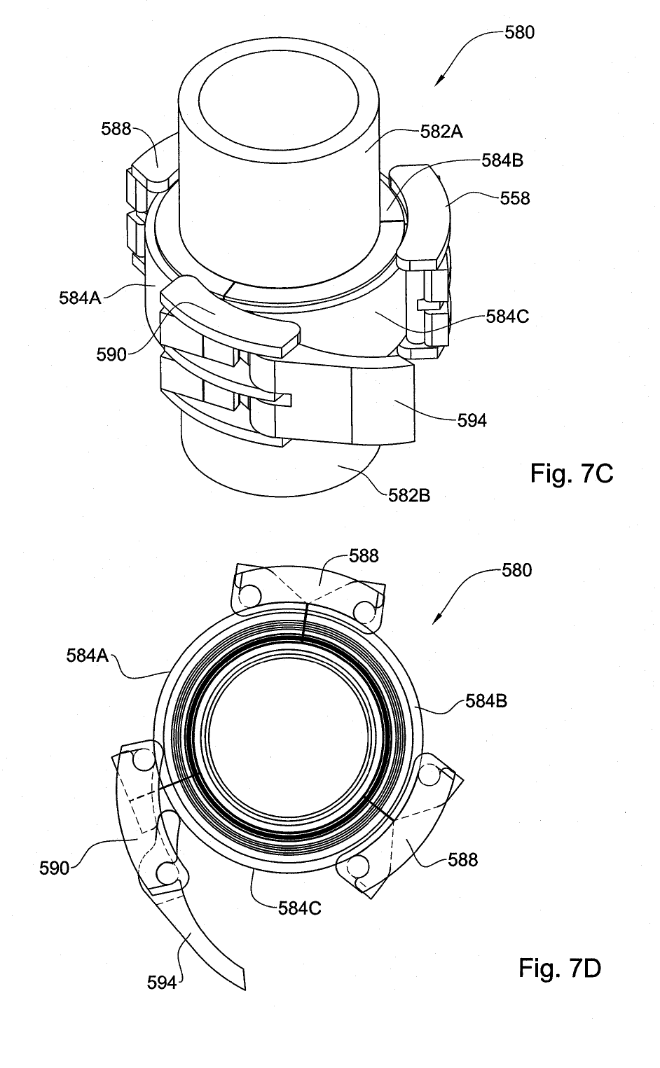

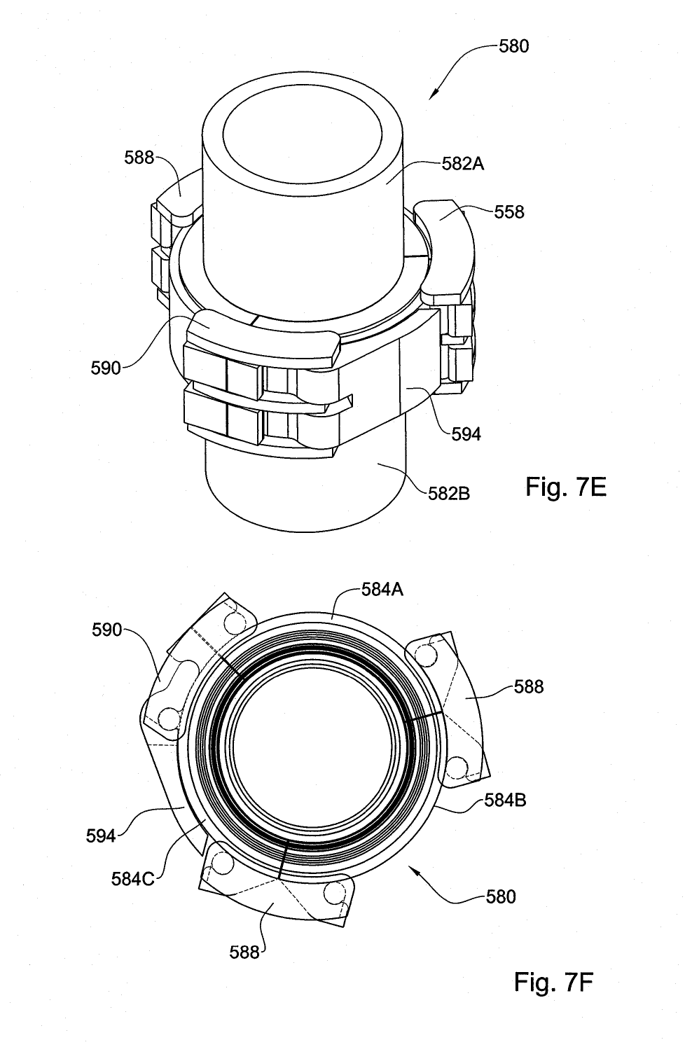

Further reference is now directed to FIGS. 6 and 7 directed to multi-shell couplers. Whilst the illustrated examples make reference to couplers of the type disclosed in FIGS. 1A-1G and 2A to 2F respectively, and are each composed of a certain number of shell segments, it is appreciated that any practical number of shell segments may be applied, depending on the size and geometry thereof.

Attention is first directed to FIGS. 6A to 6H of the drawings, wherein elements similar to elements illustrated in FIGS. 1A to 1G are designated like reference numbers, however shifted by 400.

The coupler illustrated in FIGS. 6A-6H and generally designated 410 comprises three shell segments 414A, 414B and 414C, said shell segments being substantially identical to one another and configured with a tubular element seat portion 416 each extending along an arc of 120° such that together they complete a full circular pattern.

The shell segments 414A-414C are of similar construction as disclosed in connection with the example of FIG. 1 however owing to their narrower sector the bores 448 extend at an angle with respect to one another. The half shells 414 are each configured with a flat surface 415 for engagement with the mating surface of a neighboring shell segment, at the closed position of the coupler.

As can further be seen in the drawings, each of the shell segments 414 is further configured with a pair of substantially parallely extending tubular element engagement element formations designated 430A and 430B, which in the illustrated example are radially extending ribs configured for arresting engagement with the corresponding annular grooves 426A and 426B of the tubular elements 420A and 420B, respectively.

The three shell segments 414A-414C of the coupler are securable to one another into a closed, tight position wherein the complementary tubular element seats give rise to a closed circle shape. Securing the closed state is carried out by a locking mechanism comprising a bolt guide 440 disposed at one of the bores 448 of each shell segment, and a bolt fastener 442 disposed in the other bore 448 of each shell segment.

The arrangement is such that the bolt guides 440 and the bolt fasteners 442 are cylindrical elements disposed within corresponding cylindrical bores 446 formed in each of the shell segments (and having an axis substantially parallel to a longitudinal axis extending through the assembled coupler) giving rise to a so-called floating configuration, i.e. being self-aligning such that bolts 444 may easily be introduced through the bolt guides 440 and engaged for screw fastening with the bolt fasteners (nuts) 442, thus overcoming any misalignment of the above competence on the one hand and further facilitating manipulating of the shell segments 414A-414C between a completely open position (e.g. FIGS. 6A and 6B), for easy mounting thereof about tubular elements, also at the event of restricted and inconvenient work space and tight conditions, however easily manipulable into the closed and tightly secured position as in FIGS. 6G and 6H.

The provision of two or more shell segments (three in the present example, though a greater number of shell segments may be applied, depending on the size and geometry of the tubular elements) provides for flexibility and a wide range of degrees of freedom extending between two neighboring shell segments such that the coupler is easily manipulable in its open state.

The fastening/unfastening of the coupler as well as the locking engagement thereof over the tubular elements and sealing engagement therewith are similar to the arrangement disclosed in connection with FIG. 1 above and reference is made thereto.

It is further appreciated that while in the present disclosed example the shell segments 414A-414C are substantially identical to one another, according to different examples the shell segments in one coupler may be of different design. For example, there may be provided one or more large shell segment and one or more small shell segments, respectively, however the arrangement being such that their geometry compliments to provide a closed circular shape retaining the physical principles and design as discussed hereinabove to ensure tight engagement and sealing of the two tubular elements to one another.

Turning now to FIGS. 7A-7F of the drawings, elements similar to elements illustrated in FIGS. 2A-2F are now designated with like reference numbers, however shifted by 500.

The coupler generally designated 580 is configured for sealingly coupling a pair of coaxially extending tubular elements 582A and 582B in a substantially similar fashion as discussed in connection with FIGS. 2A and 2F above. The coupler comprises a plurality (3 in the present example) shell segments 584A, 584B and 584C, wherein two neighboring shell segments 584A and 584B; 584B and 584C are pivotally secured to one another by a rigid pivot link 588 in a similar fashion as disclosed hereinabove in connection with FIG. 2, giving rise to a chain-like configuration of the coupler, while at its fully opened position. The two end shell segments 584A and 584C are configured for locking engagement with one another by a toggle-like mechanism wherein a locking end 586 of shell segment 584A is configured for locking arresting by a locking link 590 fitted with a locking lever 594 pivotally secured to said locking link 590, constituting together the toggle-type locking mechanism.

Each of the shell segments 584A-584C is configured at its respective ends with a flat surface 587 and 589 wherein at a closed position of the coupler 580, said flat surfaces are configured for flush bearing against one another.

The shell segments 584A-584C are each configured with a complementary tubular element seat 596, each configured with a pair of substantially parallel radial tubular element engagement formations, in the form of inward extending radial ribs (keys) designated 600A and 600B defining between them an annular gasket seat 604 for accommodating therein a hydraulic gasket seal 606 as discussed hereinabove.

Arresting and sealing engagement of the tubular elements 582A and 582B in a coaxial fashion is accomplished as disclosed hereinabove. However, the construction of the coupler 580 as disclosed in FIGS. 7A-7F provides an extended degree of freedom wherein the coupler may be mounted over a tubular element assembly also at restricted and tight space.

In the illustrated example, the coupler 580 comprises three shell segments of identical size and shape and being interchangeable with one another (being non- discrete). However, it is appreciated that the number of shell segments and their shape and size may differ depending on particular design and engineering requirements.

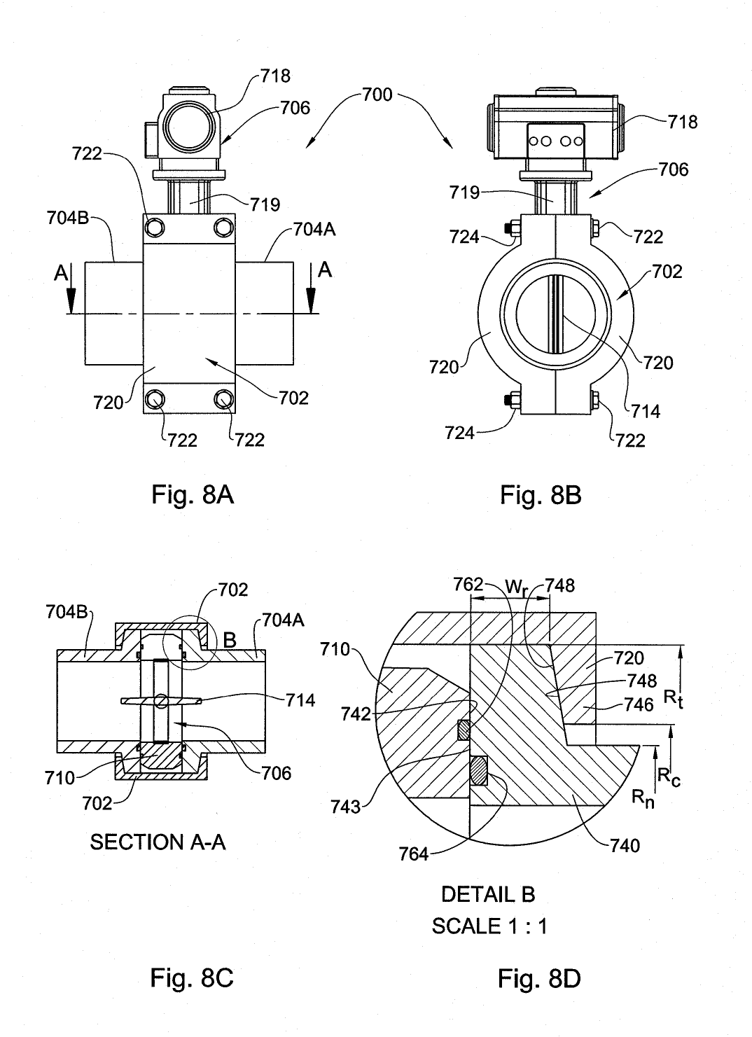

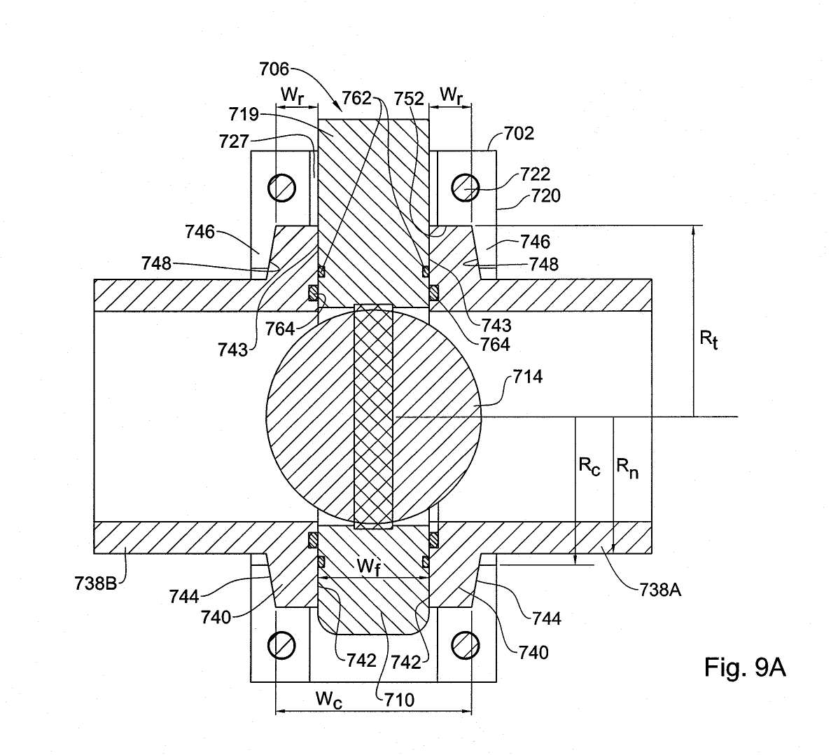

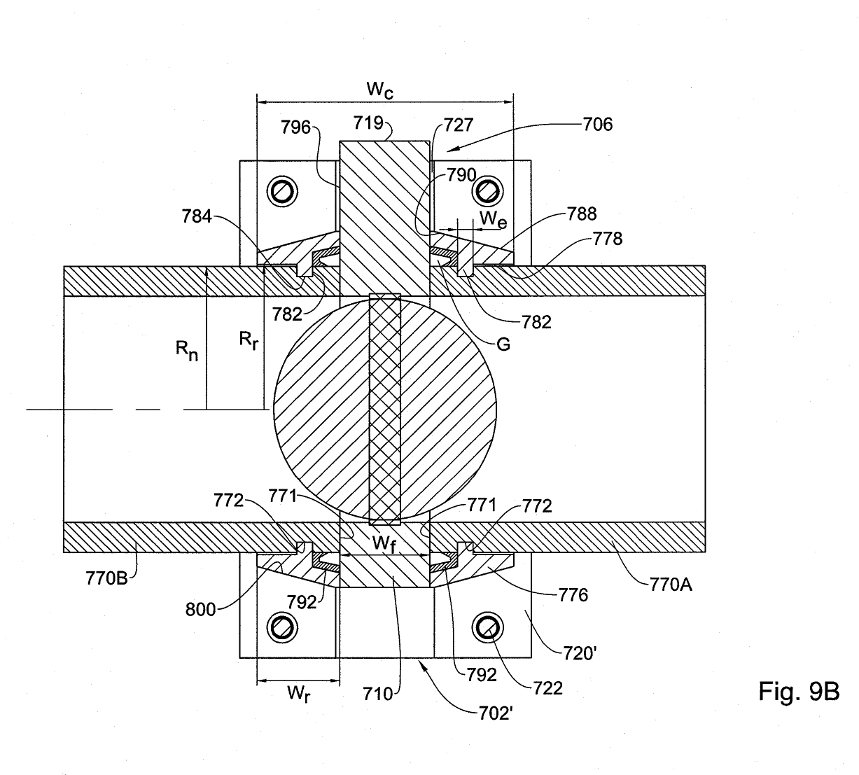

Turning now to FIGS. 8 and 9 of the drawings, there is illustrated a coupling system and a coupler therefore, configured for sealingly coupling a flow control member interposed coaxially between two neighboring tubular elements. (e.g. faucet, valve, meter, branching tubular element, etc.).

FIGS. 8A, 8B and 8C show a pipe coupling system generally designated 700, according to a further aspect of the present disclosed subject matter. The pipe coupling system 700 generally comprises a coupler assembly 702, a pair of coaxially coupled tubular elements 704A and 704B, and a flow control member 706.

The a flow control member 706 in the present example is a butterfly faucet configured with a tubular housing 710 (FIG. 8C) disposed coaxially between the neighboring tubular elements 704A and 704B, and accommodating a sealing disc 714 and an externally disposed actuator 718 articulated to the sealing disc 714 via an actuating axle 719 sealingly extending through the housing 710. It is appreciated, as will become apparent hereinafter with particular reference to FIGS. 9A and 9B of the drawings that the flow control member 706 has a nominal diameter and axial length conforming with a particular coupler.

The coupler 702 is assembled of two shell segments 720 complimenting a circular brace and secured to one another by four bolts 722 and respective nuts 724. It is however appreciated, as already discussed in connection with previous coupler examples hereinabove that the coupler may comprise any practical number of shell elements, secured to another. A radial opening 727 (FIGS. 9A and 9B) is formed symmetrically between the two shell segments 720, said opening accommodating the actuating axle 719 of the flow control member 706.

Turning now to FIG. 9A there is illustrated a first example wherein each of the tubular elements 738A and 738B is configured at its facing end with a radially projecting locking ring 740 having a flat fore face 742 and a backwards tapering rear face 744.

As can be seen also in FIG. 8D, each of the shell segments 720 of the coupler 702 is configured with a radially inwardly projection 746 having a tapering inside wall 748, inclined in compliance with the backwards tapering rear face 744 of the tubular elements 738A and 738B. As seen in the figure, the radii Rₜ of the locking ring 740 of the tubular elements corresponds with that of the surface 752 of the shell segments, whilst the radii R_{c} of the projection 746 is greater than the radii Rₙ of the tubular element, such that an annular gap resides therebetween.

The internal minimal width W_{c} of the coupler, measured at the narrowest, radial 20 location, is equal or lesser than the accumulating width W_{f} of the housing 710 of the flow control member 706 and the minimal width Wᵣ of the two locking rings 740 (measured at the most radial end), whereby W_{c}≦(W_{f}+Wᵣ+Wᵣ). This arrangement, together with the corresponding tapering surfaces, ensures tight coupling of the two tubular elements and the interposed flow control member. Thus, bracing force applied to the shell segments 720 through bolts 722 is converted to yield an axial force resultant acting to axially tighten the assembly in a sealed fashion.

Sealing is obtained by the provision of one or more sealing rings between the fore face 742 of the tubular element and the corresponding flat side faces 743 of the housing 710 of the flow control member 706. In the illustrated example a first compression sealing ring (‘O-ring’) 762 is received within an annular gasket groove formed on the flat side faces 743 of the housing 710, and a second compression sealing ring 764 is received within an annular gasket groove formed on the flat side faces 742 of the locking rings 740 of the tubular elements 738A and 738B. It is however appreciated that other sealing configurations are available. Tightening the bolts further results ingenerating compression forces, radially oriented, which forces take a major roll on coupling the coupler over the tubular element.

In fact, the radial radially inwardly projection 746 and the radially projecting locking ring 740 constitute together a tubular element engagement formation, as referred to hereinabove.

Turning now to FIG. 9B of the drawings there is illustrated a different configuration for a coupler system designed to couple two tubular elements with a flow control member coaxially interposed therebetween.

In this example each of the tubular elements 770A and 770B is formed near its fore end with an annular groove 772, in a similar fashion as disclosed in connection with the examples of FIGS. 1 to 3, 6 and 7. The tubular elements have a flat fore face 771.

A an axial displacement ring 776 is provided, said displacement ring configured as slit ring, i.e. having a slit imparting it some elasticity, though retaining its near to complete circular pattern. The displacement ring 776 has a substantially flat and coaxial an inner surface 778 having a radii Rᵣ substantially similar to the radii Rₙ of the tubular elements.

Inwardly projecting from surface 778 there is configured a radial locking projection 782 (which in the present example has a substantially rectangle cross section, i.e. having parallel side walls 782 and a flat bottom face 784, extending perpendicular to the side walls 784, said locking projection 782 having a width W₁, corresponding with (slightly less) then the width of the annular groove 772 of the tubular element. The locking projection 782 is spaced behind a fore surface 790, giving rise to a gap G accommodating a hydraulic sealing gasket 792.

An outer surface 788 of the axial displacement ring 776 tappers backwards whilst the fore face 790 is substantially flat and is radially disposed. The axial displacement ring 776 has an overall width Wᵣ.

The hydraulic sealing gasket 792 bears at one end against wall 782 of the locking projection 782 and at another end thereof against the flat side face 796 of the housing 710 of the flow control member 706.

The coupler 702′ is assembled of two shell segments 720′ complimenting a circular brace and secured to one another by four bolts 722 and respective nuts 724. It is however appreciated, as already discussed in connection with previous coupler examples hereinabove that the coupler may comprise any practical number of shell elements, secured to another.

Each shell segment 720′ is configured with a central space for accommodating the flow control member 706, confined between two tubular element coupling areas.

An inner surface 800 extends at each tubular element coupling area, said inner surface 800 tapering substantially equally as the outer surface 788 of the axial displacement ring 776.

The arrangement is such that:

(W_{f}+Wᵣ+Wᵣ)≦W_{c}

wherein:
W_{f} is the width of the of the housing 710 of the flow control member 706;
Wᵣ is the internal width of the coupler 720′;
Wᵣ is the overall width of the axial displacement ring 776

The arrangement is such that bracing force applied to the shell segments 720′ through bolts 722 is converted to yield an axial force resultant acting to axially tighten the assembly in a sealed fashion, said axial force applied through the axial displacement rings 776 and via the locking projections 782 to the tubular elements 770A and 770B, so as to tightly displace then towards one another. Tightening the bolts further results ingenerating compression forces, radially oriented, which forces take a major roll on coupling the coupler over the tubular element.

The above disclosure is suitable for any type of coupler and the securing geometry, namely number of locking ribs their thickness, depth and axial spacing, may vary depending on different engineering parameters. Likewise, the coupler disclosed is configured with locking ribs. However it may comprise locking grooves suited for engagement with corresponding ridges configured at the respective end of the tubular elements.

While there have been shown several examples of the disclosed subject matter, it is to be understood that many changes may be made therein without departing from the spirit of the disclosed subject matter, mutatis mutandis. For example, the radial tubular element engagement formations can be radially a radially outwardly extending groove configured for arresting engagement with a corresponding annular rib (at times referred to as a ‘flange’) of a respective tubular element end.

1. A coupler, comprising: two or more shell segments, each pivotally coupled at a pivot end to a rigid link, and being securable to one another at a locking end thereof by a locking mechanism, each shell segment is configured with a complimentary tubular element seat and at least a pair of substantially parallel radial tubular element engagement formations, and an annular gasket seat, wherein the two or more shell segments are pivotable between a closed position in which they complete a substantially closed shape, and an open position wherein at least one of the two or more shell segments is pivotally displaced with respect to the link and apart from one another.

2. The coupler according to claim 1, wherein the locking mechanism is a toggle mechanism comprising a locking link pivotally articulated at one end thereof to the locking end of a first shell segment and at an opposite end pivotally coupled with a toggle handle configured with a locking end for engaging with a locking shoulder configured at the locking end of a second two or more shell segment.

3. The coupler according to claim 1, wherein the link is secured to each of the two or more shell segments by one or more hinge ears extending from the pivot end of the two or more shell segments.

4. The coupler according to claim 1, wherein pivotal couplings of the two or more shell segments with the rigid link, the locking link and between the locking link and a toggle handle is facilitated through pivot pins inserted through respective pivot bores, or by pivot pins integral with the rigid link and the locking link pivotally engageable through pivot recesses configured at the respective pivot end of the shell segments and at the toggle handle.

5. A coupler, comprising: two or more shell segments each configured with a complimentary tubular element seat and at least a pair of substantially parallel radial tubular element engagement formations, and an annular gasket seat, and being securable to one another by a locking mechanism comprising a bolt guide received within respective ends of a first shell segment and a bolt fastener received within respective ends of a second shell segment.

6. The coupler according to claim 5, wherein at least one of a pair of a respective bolt guide and bolt fastener is a floating member having rotational freedom at least about an axis extending parallel to a longitudinal axis of the coupler, corresponding with a longitudinal axis of the tubular elements to be coupled thereby.

7. The coupler according to claim 5, wherein at least one of a pair of a respective bolt guide and bolt fastener is a floating member such that a floating arrangement of the bolt guide and bolt fastener is obtained by a cylindrical receptacle formed in the respective shell segment, extending substantially parallel to a longitudinal axis of the tubular element seat, and a cylindrical body rotationally received within said cylindrical receptacle, with an axis of the bolt guide and bolt fastener extending perpendicular to a roll axis of said cylindrical body.

8. (canceled)

9. A hydraulic sealing gasket made of a resilient material and having a base portion and at least one gasket leg terminating at a sealing lip, wherein radially extending support ribs are provided between an inside surface of the gasket leg and an inside surface of the base portion.

10. The hydraulic sealing gasket according to claim 9, wherein the sealing gasket has a C-like cross-section configured with a base portion and two oppositely extending gasket legs each terminating at a sealing lip, and wherein radially extending support ribs are provided between an inside surface of the gasket legs and an inside surface of the base portion.

11. The hydraulic sealing gasket according to claim 9, wherein the support ribs extend either or both from the inside surface of the base portion towards the inside surface of the gasket legs and from the inside surface of the gasket legs towards the inside surface of the base portion.

12. (canceled)

13. The hydraulic sealing gasket according to claim 9, wherein support ribs extend from both the inside surface of the base portion and the inside surface of the gasket legs, they face one another with an interstice kept between the facing support ribs.

14. The hydraulic sealing gasket according to claim 9, wherein the support ribs can extend integrally between the respective inside surface of the base portion and the inside surface of the gasket legs.

15. The hydraulic sealing gasket according to claim 9, wherein the gasket legs extend at different coaxial planes.

16. The hydraulic sealing gasket according to claim 9, wherein the base portion is stepped and is configured for sealing engagement two tubular elements of different external diameter.

17. The coupler system comprising a coupler in accordance with claim 1, wherein the coupler is configured for sealingly coupling a flow control member interposed coaxially between two neighboring tubular elements, wherein coupling between the flow control member and a tubular element is facilitated through an axial displacement ring configured for mounting over the tubular element and axially engaging therewith, and having an external tapering surface configured for bearing within the coupler and against a corresponding tapering wall thereof, whereby applying bracing force over the coupler elements entails resultant axial forces resulting in displacing the displacement ring and the tubular element articulated thereto towards the flow control member.

18. (canceled)

19. The coupler system according to claim 17, wherein axial engagement between the displacement ring and the tubular element is facilitated through a radial grove configured at one of the outside surface of the tubular element and an inside surface of the displacement ring, and a radial locking projection extending from the other of the outside surface of the tubular element and an inside surface of the displacement ring, said locking projection configured for projection into said radial grove such axial forces applied to the displacement ring are transferred to the tubular element.

20-23. (canceled)
